(19) United States
(12) Patent Application Publication
(10) Pub. No.: US 2023/0120160 A1
(43) Pub. Date: Apr. 20, 2023

(54) AUTHENTICATION AGGREGATOR

(71) Applicant: Invesco Holding Company (US), Inc., Atlanta, GA (US)

(72) Inventors: Jason Scott Oh, Lake Forest, IL (US); Peter Maarten van Hengel, Darien, CT (US); Kyle Kleinbart, Short Hills, NJ (US)

(21) Appl. No.: 17/966,813

(22) Filed: Oct. 15, 2022

Related U.S. Application Data
(60) Provisional application No. 63/256,117, filed on Oct. 15, 2021.
(60) Provisional application No. 63/353,909, filed on Jun. 21, 2022.

(51) Int. Cl. H04L 9/40

(52) U.S. Cl. CPC H04L 63/08

(57) ABSTRACT

An authentication aggregator facilitates access to a remote service selected from among multiple, independent secure services. Libraries of authentication protocols and application programming interfaces are maintained for access to each secure service, and a superset of user interaction details can be selected and presented for a standardized user experience at a network location such as a website from which access to the secure service is requested.

### RELATED APPLICATIONS

This application claims priority to U.S. Prov. App. No. 63/256,117 filed on Oct. 15, 2021, and U.S. Prov. App. No. 63/353,909 filed on Jun. 21, 2022. The entire content of each of the foregoing applications is hereby incorporated by reference.

### TECHNICAL FIELD

This disclosure relates to a user interface that aggregates authentication and access to multiple secure services.

### BACKGROUND

A variety of secure services are available through public data networks. This may create difficulties for end users and secure service providers when multiple service providers offer similar resources, particularly where an end user is requesting access to one of the secure services indirectly, e.g., through an intermediate resource, such as a web site hosted by, or containing content from, an entity different than the secure service provides. For example, a user may acquire digital content from a third party website that the user wishes to store in personal cloud storage, or the user may wish to acquire a cryptocurrency for personal use from an online resource.

There remains a need for authentication middleware that can provide a single point of contact for user selection of, and authentication to, a secure service from among multiple available alternatives.

### SUMMARY

An authentication aggregator facilitates access to a remote service selected from among multiple, independent secure services. Libraries of authentication protocols and application programming interfaces are maintained for access to each secure service, and a superset of user interaction details can be selected and presented for a standardized user experience at a network location such as a website from which access to the secure service is requested.

### BRIEF DESCRIPTION OF THE DRAWINGS

The foregoing and other objects, features and advantages of the devices, systems, and methods described herein will be apparent from the following description of particular embodiments thereof, as illustrated in the accompanying drawings. The drawings are not necessarily to scale, emphasis instead being placed upon illustrating the principles of the devices, systems, and methods described herein. In the drawings, like reference numerals generally identify corresponding elements.

FIG. 1 is a diagram of a computing device for use in the methods and systems described herein.

FIG. 2 shows a user interface employing authentication aggregation.

FIG. 3 shows a system for authentication aggregation.

FIG. 4 shows a method for authentication aggregation.

FIG. 5 illustrates a process for obtaining an access token.

FIG. 6 illustrates a process for using an access token.

### DESCRIPTION

Embodiments will now be described with reference to the accompanying figures. The foregoing may, however, be embodied in many different forms and should not be construed as limited to the illustrated embodiments set forth herein.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately” or the like, when accompanying a numerical value, are to be construed as indicating a deviation as would be appreciated by one of ordinary skill in the art to operate satisfactorily for an intended purpose. Similarly, words of approximation such as “approximately” or “substantially” when used in reference to physical characteristics, should be understood to contemplate a range of deviations that would be appreciated by one of ordinary skill in the art to operate satisfactorily for a corresponding use, function, purpose, or the like. Ranges of values and/or numeric values are provided herein as examples only, and do not constitute a limitation on the scope of the described embodiments. Where ranges of values are provided, they are also intended to include each value within the range as if set forth individually, unless expressly stated to the contrary. The use of any and all examples, or exemplary language (“e.g.,” “such as,” or the like) provided herein, is intended merely to better describe the embodiments and does not pose a limitation on the scope of the embodiments. No language in the specification should be construed as indicating any unclaimed element as essential to the practice of the embodiments.

In the following description, it is understood that terms such as “first,” “second,” “top,” “bottom,” “up,” “down,” and the like, are words of convenience and are not to be construed as limiting terms unless specifically stated to the contrary.

To provide an overall understanding of the disclosure, certain illustrative implementations will now be described, including systems, methods, and devices for creating, redeeming, and publishing price information for shares of exchange-traded funds, as well as the creation and use of substitute baskets in any of the foregoing. However, it will be understood by one of ordinary skill in the art that the systems and methods described herein may be adapted and modified as is appropriate for the application being addressed and that the systems and methods described herein may be employed in other suitable applications, and that such other additions and modifications will not depart from the scope thereof. Generally, the computerized systems described herein may comprise one or more engines, platforms, modules, compute instances, or the like, which may include a processing device or devices, such as a computer, microprocessor, logic device, or other device or processor that is configured with hardware, firmware, and/or software to carry out one or more of the computerized methods described herein.

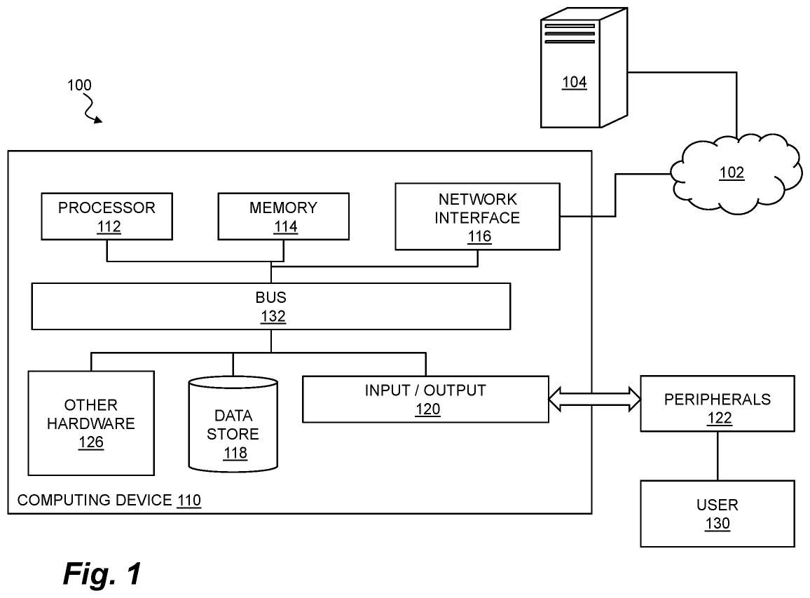

FIG. 1 is a diagram of a computer system 100 for use in the methods and systems described herein. In general, the device 100 of FIG. 1 may be used to implement a website, a transaction authentication aggregator, a third party transaction resource, or any of the other platforms or entities described herein, and may also or instead be used to perform various steps of the methods described herein, e.g., when programmed by computer executable code stored in memory and executable by a processor.

The computer system 100 may include a computing device 110 connected to a network 102, e.g., through an external device 104. The computing device 110 may be or include any type of network endpoint or endpoints as described herein. For example, the computing device 110 may include a desktop computer workstation. The computing device 110 may also or instead be any other device that has a processor and communicates over a network 102, including without limitation a laptop computer, a desktop computer, a personal digital assistant, a tablet, a mobile phone, a television, a set top box, a wearable computer, and so forth. The computing device 110 may also or instead include a server, or it may be disposed on a server or within a virtual or physical server farm. In certain aspects, the computing device 110 may be implemented using hardware (e.g., in a desktop computer), software (e.g., in a virtual machine or the like), or a combination of software and hardware (e.g., with programs executing on the desktop computer), and the computing device 110 may be a standalone device, a device integrated into another entity or device, a platform distributed across multiple entities, or a virtualized device executing in a virtualization environment.

The network 102 may include any network or combination of networks, such as one or more data networks or internetworks suitable for communicating data and control information among participants in the computer system 100. The network 102 may include public networks such as the Internet, private networks, and telecommunications networks such as the Public Switched Telephone Network or cellular networks using third generation cellular technology (e.g., 3G or IMT-2000), fourth/fifth generation cellular technology (e.g., 4G, LTE, MT-Advanced, E-UTRA, 5G, etc.) or WiMAX-Advanced (IEEE 802.16m)) and/or other technologies, as well as any of a variety of corporate area, metropolitan area, campus, or other local area networks or enterprise networks, along with any switches, routers, hubs, gateways, and the like that might be used to carry data among participants in the computer system 100. The network 102 may also include a combination of data networks, and need not be limited to a strictly public or private network.

The external device 104 may be any computer or other remote resource that connects to the computing device 110 through the network 102. This may include threat management resources such as any of those contemplated above, gateways or other network devices, remote servers or the like containing content requested by the computing device 110, a network storage device or resource, a device hosting content, or any other resource or device that might connect to the computing device 110 through the network 102.

The computing device 110 may include a processor 112, a memory 114, a network interface 116, a data store 118, and one or more input/output devices 120. The computing device 110 may further include or be in communication with one or more peripherals 122 and other external input/output devices 124.

The processor 112 may be any as described herein, and in general may be capable of processing instructions for execution within the computing device 110 or computer system 100. In one aspect, the processor 112 may be capable of processing instructions stored in the memory 114 or on the data store 118.

The memory 114 may store information within the computing device 110 or computer system 100. The memory 114 may include any volatile or non-volatile memory or other computer-readable medium, including without limitation a Random-Access Memory (RAM), a flash memory, a Read Only Memory (ROM), a Programmable Read-only Memory (PROM), an Erasable PROM (EPROM), registers, and so forth. The memory 114 may store program instructions, program data, executables, and other software and data useful for controlling operation of the computing device 110 and configuring the computing device 110 to perform functions for a user. While a single memory 114 is depicted, it will be understood that any number of memories may be usefully incorporated into the computing device 110. For example, a first memory may provide non-volatile storage such as a disk drive for permanent or long-term storage of files and code even when the computing device 110 is powered down, and a second memory such as a random-access memory may provide volatile (but higher speed) memory for storing instructions and data for executing processes.

The network interface 116 may include any hardware and/or software for connecting the computing device 110 in a communicating relationship with other resources through the network 102. This may include connections to resources such as remote resources accessible through the Internet, as well as local resources available using short range communications protocols using, e.g., physical connections (e.g., Ethernet), radio frequency communications (e.g., WiFi or Bluetooth), optical communications, (e.g., fiber optics, infrared, or the like), ultrasonic communications, or any combination of these or other media that might be used to carry data between the computing device 110 and other devices. The network interface 116 may, for example, include a router, a modem, a network card, an infrared transceiver, a radio frequency (RF) transceiver, a near field communications interface, a radio-frequency identification (RFID) tag reader, or any other data reading or writing resource or the like. More generally, the network interface 116 may include any combination of hardware and software suitable for coupling the components of the computing device 110 to other platforms, computing or communications resources, and so forth.

The data store 118 may be any internal memory store providing a computer-readable medium such as a disk drive, an optical drive, a magnetic drive, a flash drive, memory card, or other device capable of providing mass storage for the computing device 110. The data store 118 may store computer readable instructions, data structures, program modules, and other data for the computing device 110 or computer system 100 in a non-volatile form for subsequent retrieval and use. The data store 118 may store computer executable code for an operating system, application programs, and other program modules, software objects, libraries, executables, and the like the like. The data store 118 may also store program data, databases, files, media, and so forth.

The input/output interface 120 may support input from and output to other devices that might couple to the computing device 110. This may, for example, include serial ports (e.g., RS-232 ports), universal serial bus (USB) ports, optical ports, Ethernet ports, telephone ports, audio jacks, component audio/video inputs, HDMI ports, and so forth, any of which might be used to form wired connections to other local devices. This may also or instead include an infrared interface, RF interface, magnetic card reader, or other input/output system for coupling in a communicating relationship with other local devices.

The peripherals 122 may include any device or combination of devices used to provide information to or receive information from the computing device 110. This may include human input/output (I/O) devices such as a keyboard, a mouse, a mouse pad, a track ball, a joystick, a microphone, a foot pedal, a camera, a touch screen, a scanner, or other device that might be employed by the user 130 to provide input to the computing device 110. This may also or instead include a display, a speaker, a printer, a projector, a headset, or any other audiovisual device for presenting information to a user or otherwise providing machine-usable or human-usable output from the computing device 110. The peripheral 122 may also or instead include a digital signal processing device, an actuator, or other device to support control of or communication with other devices or components.

Other hardware 126 may be incorporated into the computing device 110 such as a co-processor, a digital signal processing system, a math co-processor, a graphics engine, a video driver, and so forth. The other hardware 126 may also or instead include expanded input/output ports, extra memory, additional drives (e.g., a DVD drive or other accessory), and so forth.

A bus 132 or combination of busses may serve as an electromechanical platform for interconnecting components of the computing device 110 such as the processor 112, memory 114, network interface 116, other hardware 126, data store 118, and input/output interface 120. As shown in the figure, each of the components of the computing device 110 may be interconnected using a system bus 132 or other communication mechanism for communicating information.

Methods and systems described herein can be realized using the processor 112 of the computer system 100 to execute one or more sequences of instructions contained in the memory 114 to perform predetermined tasks. In embodiments, the computing device 110 may be deployed as a number of parallel processors synchronized to execute code together for improved performance, or the computing device 110 may be realized in a virtualized environment where software on a hypervisor or other virtualization management facility emulates components of the computing device 110 as appropriate to reproduce some or all of the functions of a hardware instantiation of the computing device 110.

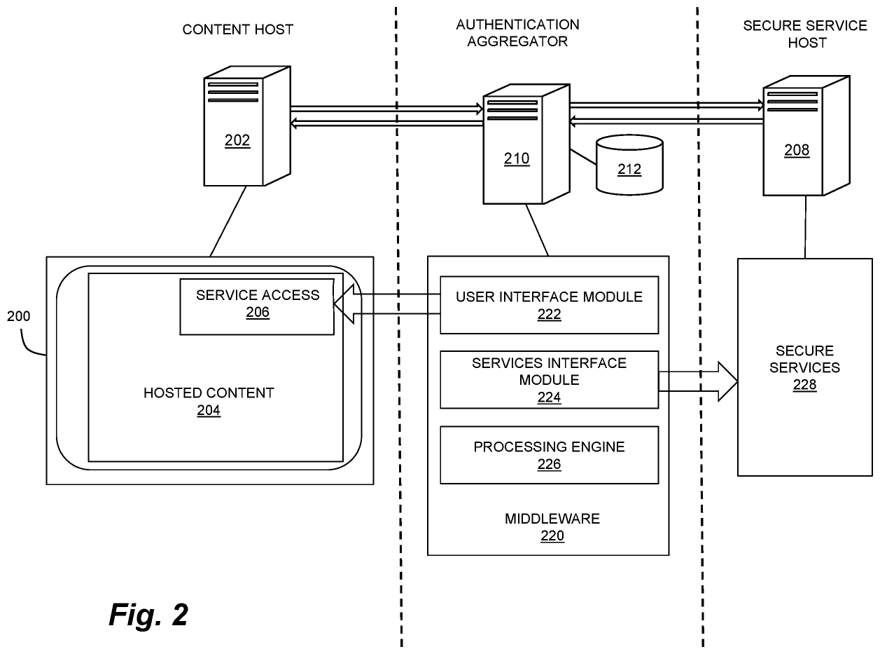

FIG. 2 shows a user interface supporting authentication aggregation. In general, the interface 200 may be rendered by a local application executing on a computing device, such as any of the computing devices described herein, and hosted on a remote platform such as a content host 202 for a company that provides content over a data network, e.g., via a web page or the like. The user interface 200 may be rendered, e.g., using a standalone application, a web browser, or the like, along with any accompanying display hardware used to physically present the user interface 200 to the user. In general, the interface 200 may provide any hosted content 204 such as company information, product descriptions, marketing information, news, editorial content, third party content, and so forth. In general, the hosted content 204 may include text, graphics, multimedia, and so forth.

The user interface 200 may include a control 206 for receiving a user request for service access, such as a purchase button, download button, content retrieval button, or the like to facilitate access, by a user viewing the hosted content 204, of a third party secure service, e.g., to acquire digital content, purchase or sell items, and so forth. In one aspect, the user interface 200 may be rendered using any suitable hardware including, without limitation, a computer screen, a smart phone screen, a tablet screen, a virtual reality headset, or any suitable display hardware. The user interface 200 may also or instead be rendered using a touch screen, haptic device, or other non-visual interactive hardware. In another aspect, the user interface 200 may display content using a variety of software technologies and communication media. For example, the user interface 200 may display a web page containing a request. This may also or instead include any combination of server-side technologies, client-side technologies, or combination of the foregoing. Thus, for example, the user interface 200 may include one or more browser extensions, browser plugins, client-side interpreters or virtual machines, user applications (including mobile apps), popup windows, and so forth. With respect to communication media, the user interface 200 may display an electronic mail containing a request, a text message containing a request, a chat window containing a request, and so forth.

The control 206 for service access may also include or deploy other user interface elements that may be launched, e.g., in response to another user control such as a button, icon, link, or the like within the hosted content 204. For example, the user interface 200 may include a modal window, popup window, side panel, form, or other user interface element, along with associated code for use in user authentication and related functions described herein. In another aspect, the control 206 may be dynamically deployed, e.g., in response to a semantic analysis or keyword analysis of the hosted content 204, or user profile information or other contextual data. Thus, in one aspect, a number of different controls 206 may be stored, with a specific one of the controls 206 selected and deployed as dynamic content within the hosted content 204 based on other contextual information available when the hosted content 204 is rendered for a user.

Where a secure service 208 such as a cloud computing resource, external ecommerce site, brokerage platform, or the like is necessary or helpful for performing the requested user action, the control 206 in the user interface may advantageously provide an initial redirection of the requested user action to an authentication aggregator 210 that is configured for access to multiple different secure services 208, e.g., from different third parties.

The authentication aggregator 210 may include any of the computing devices described herein. In general, the authentication aggregator 210 operates to authenticate a user to one of the secure services 208 and to facilitate a user-requested operation without requiring the user to leave the hosted content 204, or more generally, the content host 202 that is rendering the user interface 200. To support this operation, the authentication aggregator 210 may include a database 212 or other data repository or the like storing information useful for accessing secure services 208 that are remotely hosted by third parties. For example, this may include a list of available secure services 208 for a particular service type, a library of authentication models for these secure services 208, and a library of application programming interfaces (APIs) for these secure services 208.

It will be understood that, while the authentication aggregator 210 is illustrated as a standalone device in FIG. 2, the term “authentication aggregator” as used herein is intended to refer to any of the hardware and/or software supporting use of different secure services, including any combination of software and hardware executing on a user device, the content host 202, and secure services 208, as well as the authentication aggregator 210 connected between these other components. Thus, for example, in one aspect, the authentication aggregator 210 may include the user interface 200, which may locally manage the user experience and transaction workflow for the user, and/or computer executable code supporting the user interface 200. The authentication aggregator 210 may also or instead include hardware and/or software that is stored and/or executing on the content host 202, such as a user control in the user interface 200 linking to a remote instance of the authentication aggregator 210. Components of the authentication aggregator 210 may, for example, include widgets, server-side script(s), client-side script(s), embedded tools or content, and so forth, any of which may be stored on the content host 202 or a user device, or some combination of these. The authentication aggregator 210 may also or instead include supporting hardware and software such as the authentication aggregator 210 illustrated in FIG. 2, which connects the user-facing control 206 in the user interface 200 with multiple external secure services 208. All such meanings are intended to fall within the scope of “authentication aggregator,” and the authentication aggregator 210 should be understood to include all such embodiments unless a more specific meaning is explicitly provided or otherwise clear from the context.

In response to an access request received through the control 206, the authentication aggregator 210 may be configured (e.g., by computer executable code stored in a memory of the authentication aggregator 210 and executable by a processor of the authentication aggregator 210 to perform the corresponding steps) to offer a number of different secure services 208 to a requesting user, and to coordinate authentication and a subsequent execution of requested services at a selected one of the secure services 208. It will be understood that while a single authentication aggregator 210 is shown, any number of authentication aggregators 210 may be used to support user transactions via the control 206.

Although described in terms of a user interface 200 for a web page or the like, it will be understood that the control 206 for performing the requested user operation may also or instead be embedded in other content such as a hyperlink in a text or electronic mail communication, or as an active element within a social media platform or a virtual or augmented reality environment. Thus, the control 206, and more generally, use of the authentication aggregator 210, may usefully be deployed in a variety of contexts other than a web page or other web content.

In one aspect, the methods and systems described herein may be deployed as middleware supporting authentication aggregation, e.g., through the use of embeddable transactions or the like. As such, there is disclosed herein a middleware system 220 for aggregating authentication to secure services, the middleware system 220 including the database 212, a user interface module 222, a services interface module 224, and a processing engine 226. The database 212 may store information for a plurality of external secure services, such as a private key, an application programming interface, and an authentication protocol for each of the plurality of external secure services. This may generally include any of the keys or other cryptographic material, application programming interfaces, and/or authentication protocols described herein. The user interface module 222, which may support any of the user interfaces described herein, may be configured to receive a response to request for processing from a user device through a data network, or more generally to support programmatic interactions with the user interface 200 presented to the user on a user device. The services interface module 224 may be configured to communicate with the plurality of external secure services in order to facilitate authentication and use of corresponding services.

The processing engine 226 may generally function to manage use of the user interface module 222 and the services interface module 226 to support access to and use of secure services 228 through the authentication aggregator 210. For example, the processing engine 226 may be configured to process the request received through the user interface 200 by redirecting the user device to an authenticator for authenticating a user of the device using a corresponding one of the authentication protocols, to disambiguate a processing parameter for the request, to establish a secure connection with a user-selected secure service of the plurality of external secure services using a corresponding one of the private keys, and to initiate processing of the request through the secure connection with the user-selected secure service using a corresponding one of the application programming interfaces for programmatic access to the user-selected secure service.

The processing engine may be further configured to receive a selection of the user-selected secure service from the user device, and to select the corresponding one of the authentication protocols, private keys, and application programming interfaces for initiating processing of the request with the user-selected secure service. In general, the middleware may be deployed as any combination of hardware and software suitable for supporting the aggregation of authentication processes for multiple, separate secure services.

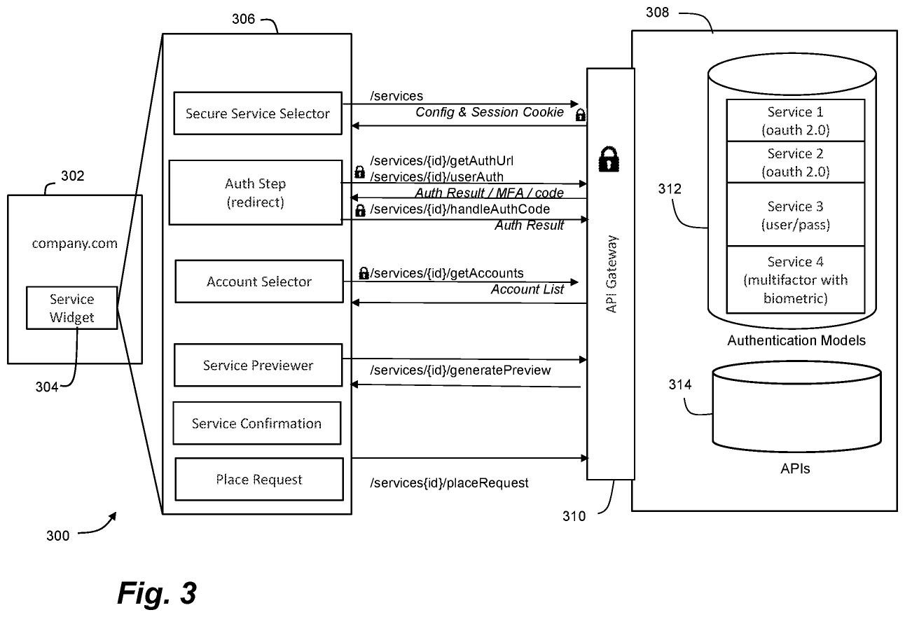

FIG. 3 shows a system for authentication aggregation. In general, a host 302 within the system 300 may provide a widget 304 or any of the other controls described herein (such as the control 206 of FIG. 2), which may be deployed within a website or other hosted content. The widget 304 may generally support the selection and use of a secure service from among multiple service providers as described herein. For example, this may include digital content retrieval, secure media streaming, electronic commerce transactions, digital signatures or timestamping, secure payment processing, financial transactions such as stock or cryptocurrency purchases, or any other cryptographically supported or otherwise secured services or transactions or the like.

The work flow 306 for the widget 304 that supports authentication aggregation may be embodied in computer executable code supporting operation of the purchase widget 304. As described herein, the code may be stored on the host 302, on an end user computer, on an authentication aggregator 308, or some combination of these, and may be executable to operate as described herein. The work flow 306 may initially include a selection of a suitable secure service from among a number of secure services available to process the request. The widget 304 may initially request designation from the user of a particular service, e.g., by presenting a list of available services to the user. The available services may be displayed, e.g., as a drop down list, a text input search box, a radio button, check boxes, or any other suitable interface control for receiving a user selection from among a discrete, finite set of available choices.

In one aspect, the widget 304 may support user creation of an account through the purchase widget 304, e.g., where the user wishes to use a secure service that requires user credentials, but the user has not previously registered with the desired secure service. In general, this may be handled through the authentication aggregator, or a user may be initially redirected to a registration resource, identity management platform, or other resource associated with the secure service and used to support new user registrations.

When a user initiates a service request through the widget 304, the widget 304 may access an API gateway 310 for an authentication aggregator 308, such as any of the authentication aggregators described herein. The API gateway 310 may generally support access to external secure services through the authentication aggregator 308 using authentication protocol data 312 and API data 314 stored by the authentication aggregator 308. As described herein, the authentication protocol data 312 may generally include data providing authentication details for each service accessible through the authentication aggregator 308, such as identity management platforms, standardized or proprietary authentication protocols, authentication failure actions, and so forth. For example, this may include data identifying trusted third party resources for completing authentication, or identifying a specific authentication protocol used by one of the secure services. The API data 314 may generally specify a programming interface for accessing one of the secure services accessible through the authentication aggregator. This may include data types, objects, call parameters, and so forth, that might be used by the authentication aggregator 308 to perform a requested action and/or report results to the user.

It will be understood that a variety of secure authentication models are known in the art and may be employed by a secure service to authenticate users. As used herein, an authentication protocol is generally intended to refer to a specific, shared protocol for authentication, and an authentication model or secure authentication model is intended to refer to an authentication protocol (or group of authentication protocols), as well as programmatic details (including the user interface and/or user experience) used to deploy an authentication protocol for user authentication as described herein. For example, a broker may use OAuth, an open standard commonly used to control access to services and data over a network, e.g., through websites, cloud applications and services, and so forth, to obtain a token for access to a secure service provider. In this case, the authentication model may specify either OAuth 1.0 or OAuth 2.0. The authentication model may also specify details of a popup window or browser extension used to gather user authentication details. Other techniques may also or instead be employed. For example, a secure service may use OpenID to obtain a signed assertion of identity from an identity provider that can be presented to the requested service. In another aspect, Web 3.0 authentication techniques, e.g., using public-key authentication of user identity, decentralized authentication protocols, distributed authentication protocols, or other decentralized Web 3.0 trust mechanisms, may be used as security protocols for authentication as described herein.

A secure service may also or instead use a standardized or propriety authentication model based on user credentials, identity provider platforms, hardware security services (e.g., a Trusted Platform Module or other hardware on a user device), certificates, keys, authentication factors (e.g., hardware tokens, biometrics, electronic mail or instant messaging identifiers, and so forth), or any combination of the foregoing. Through the selected authentication model, a user may prove identity and/or obtain authorization to use a secure service. In one aspect, the authentication to the secure service may be performed in a separate window (e.g., a modal window, pop up window, or the like), e.g., to explicitly separate the authentication process from other interactions with the host 302 in order to deter inadvertent or intentional host access to authentication data.

Once a user has successfully authenticated to a secure service, the widget 304 may select a corresponding API model from a library of APIs stored by the authentication aggregator 308. In general, this API data may be stored on a user device, the host 302, the widget 304, the authentication aggregator 308, or any combination of these. Each API model may, for example, include data formats, security specifications, function/procedure definitions, and so forth. Where there are applicable industry standards, these may also or instead be included in the programming interface description. For example, an API model may include data, features, or function definitions conforming to the Financial Information eXchange protocol for real-time exchange of information related to securities transactions. In another example, an API model may conform to Payment Card Industry Data Security Standard (PCI DSS) standards for credit/debit card transactions. In another aspect, an API model may conform to the Health Insurance Portability and Accountability (HIPPA) Act, the General Data Protection Regulation of the European Union, or any other suitable regulations, industry standards, or the like applicable to a secure service accessed through the widget 304.

It will be understood that other data may also or instead be stored by the authentication aggregator 308 for each secure service. For example, the authentication aggregator 308 may store data such as web or IP addresses for accessing each service, terms of service/use (which may be used, e.g., to verify user consent if/as appropriate), and any other data necessary or helpful to support the selection and use of secure services as described herein.

Using an API model for the user-selected service, the purchase widget 304 may then check for available accounts. For example, where a user has multiple accounts, e.g., for different family members, for home and work use, and so forth, the widget 304 may explicitly disambiguate the account in order to permit account-specific, rather than user-specific, access to secure services. For example, the widget may query the secure service for available accounts and present a resulting list to a user so that the user can select an account for use of the secure service. Where the secure service does not support multiple accounts for a single authenticated user, this step may be omitted.

Once a user has been authenticated/authorized to a secure service, and with an account selected, the user may employ the secure service using the widget 304, or some other interface supported by the authentication aggregator 308 or the host 302. In one aspect, the purchase widget 304 may preview a response to a service request, e.g., to facilitate confirmation by the user before the requested action is committed to the secure service. Any suitable confirmation may also be communicated to the user through the widget 304, or through some other medium such as an electronic mail, instant message, or the like.

An authentication aggregator as described herein may have a variety of additional features and advantages.

In one aspect, the authentication aggregator usefully facilitates placement of a provider-agnostic authentication tool at any point in a network, a workflow, or a user experience where the user of a secure service might be relevant. Thus, for example, a company may offer an option to purchase the company's stock on a company website (e.g., on a home page, an investor relations page, or some other location on the website), or the company may have the widget 304 published on an external host such as a website that offers financial news, data, commentary, or personal financial management tools, or in an advertisement dynamically presented to a user, e.g., based on search keywords, web content, or other context.

As another example, a manufacturer of goods may offer an option to purchase a particular product on the company's website in a manner that lets the user select the retail venue through which the product is purchased. More generally, a transaction option may be provided at any locus where user interest in a transaction might be generated, such as an informational web page. In another aspect, the authentication aggregator may be dynamically deployed on the fly at any suitable location based upon website semantic content, user navigation or search history, or other user context or the like.

In another aspect, the authentication aggregator may provide a user-facing transaction engine with a superset of features from multiple underlying transaction hosts so that the company providing aggregated access to services can provide a visually and functionally uniform user experience consistent with the host's website design or desired workflow. In another aspect, information relating to the selection of, and authentication to, a secure service may be stored on a user device to facilitate reuse as appropriate. For example, this information may be stored locally on a user's machine, e.g., as a session token, authentication or refresh token, or other cookie or the like, e.g., in a browser cache, or at the website hosting the authentication aggregator, or using any other suitable technique or combination of techniques.

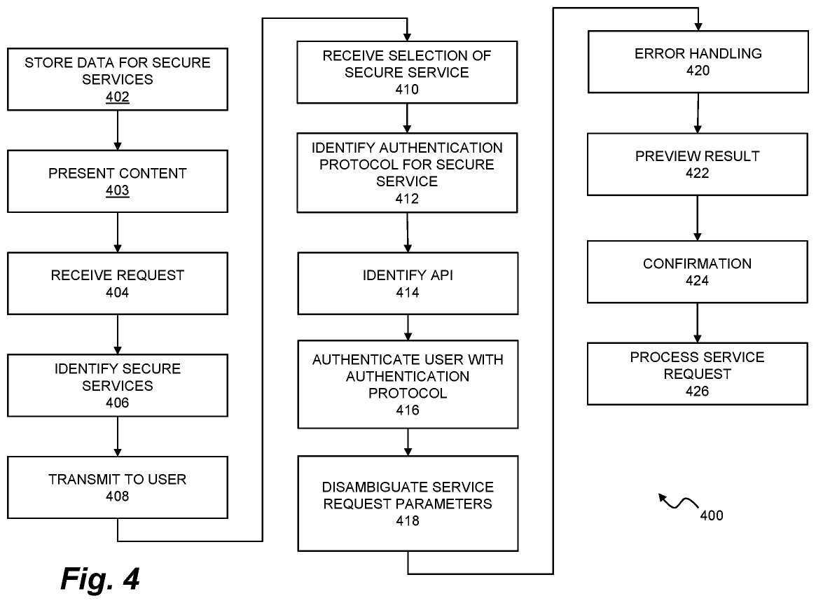

FIG. 4 shows a method for authentication aggregation. In one aspect, the systems and methods described herein may be adapted to support point-of-interaction access to remote secure services such as transaction engines, cloud computing resources, media sources, and so forth. A method for supporting embeddable transactions using these techniques may be deployed in a variety of forms, e.g., by coupling transaction or workflow logic with identity assertions. In one aspect, components may be associated with a service or function button or the like embedded in a web page, an electronic mail, an instant message, or other medium. In another aspect, components may be hosted by a remote resource that provides services or middleware to support authentication aggregation as described herein. In another aspect, components may be deployed as a software development kit or other computer code associated with a website or other remote service or resource that might be accessed using a button or other user interface control from a user device. More generally, components of the method may be deployed or arranged across a number of these resources or any of the other computing devices described herein in a manner consistent with user access to the authentication aggregator and associated functions from a user device as described herein.

As shown in step 402, the method 400 may include storing data for various secure services that might be used to support a requested operation. This may, for example, include storing a database of a plurality of authentication protocols, each one of the plurality of authentication protocols associated with one of the plurality secure services. This may also or instead include storing a database of a plurality of application programming interfaces, each one of the plurality of application programming interfaces associated with one of the plurality of secure services. This may also or instead include storing a database of private keys, each one of the private keys used for securing communications with one of the plurality of secure services. In general, this data may be stored locally on a client device, e.g., in a widget, app, browser extension, or the like, or the data to support authentication and/or downstream services may be hosted by middleware that supports an authentication aggregator.

In one aspect, this includes storing a mapping of programming interfaces for diverse secure services to a single, common user interface and/or programming interface for use by the authentication aggregator. That is, each third party programming interface for one of the secure services may be stored by the authentication aggregator and associated with a visual and functional mapping of the third party programming interface to a common user interface and user experience specified by the authentication aggregator, or alternatively, by a host using the authentication aggregator to support multi-service authentication. In this way, a user of an embedded secure function may be presented with a user interface that is functionally consistent for all users, independent of the selection of a particular, underlying secure service. This also advantageously facilitates adaptation of the user experience to the visual or functional context of the host of the embedded secure function, more specifically so that the host can manage the embedded secure function in a manner that is independent from work flows, data entry forms, and branding of various secure services that the user might select.

As shown in step 403, the method 400 may include presenting an embedded secure function to a user, e.g., within a user interface of a device. In general, the embedded secure function facilitates an operation or function using a secure service, such as any of the secure services described herein. This may include any operation that might usefully be performed or otherwise supported using a computing device coupled to a network, also as described herein.

The user interface that presents the embedded secure function may, for example, include a web page containing the embedded secure function, an electronic mail containing the embedded secure function (or an email client supporting display of the electronic mail), an instant message containing the embedded secure function (or a supporting instant messaging application or the like), a virtual reality environment containing the embedded secure function, an augmented reality environment that overlays the embedded secure function in a video display, or any other software, hardware, or combination of the foregoing interactively presenting the embedded secure function to a user for interactions.

As shown in step 404, the method 400 may include receiving a request for processing (e.g., for use of a secure service) from a user within a user interface of a device. This may include the use of a control associated with an embeddable secure function, such as a button or other user interface control or the like supported by computer code that permits a user of the device to specify the embedded secure function from within the user interface. The control may receive a user action indicating intent to perform an operation related to the use of a secure service. In general, the control may capture user intent to initiate such an operation without initially resolving all details related to the requested operation. Thus, the indication of user intent may include various degrees of ambiguity or uncertainty, which may be disambiguated using the techniques described herein. The embedded secure function may, for example, include a hyperlink to an authentication aggregator, such as any of the authentication aggregators described herein, and may specify an item or other target or objective of a transaction, or any other user-initiated operation. The hyperlink may be hosted on a website, transmitted to the user in an electronic mail or instant message, or otherwise presented to the user for use in accessing the authentication aggregator. When the user selects the hyperlink, the user may be directed to the authentication aggregator, which may be prepopulated with information (such as an identification of the item, target, objective, operation, or the like) related to the user request. In another aspect, the embedded secure function may be deployed as an embed code, as a quick response code presented on a product or in broadcast media, or as a software development kit installed on a website that hosts the embedded secure function. These deployments may provide various combinations of server-side, client-side, or remotely hosted support for an operation that is initiated by the embedded secure function.

As shown in step 406, the method 400 may include identifying secure services. The number and type of secure services may depend on the nature of the request associated with the embedded secure function. For example, the secure services may include a number of broker platforms, a number of cryptocurrency exchanges, a number of content sources, a number of electronic commerce websites, a number of non-fungible token websites, a number of digital wallets, a number of banking websites, and so forth.

As shown in step 408, the method 400 may include transmitting the identified secure services (or a selected subset of the identified secure service) to the user device for presentation in the user interface. Where multiple alternative secure services are available, this permits an initial disambiguation step by resolving the user selection to a single user-selected secure service for performing the operation requested in the embedded secure function. In another aspect, a list of the secure services available for the requested operation may be locally stored on the user device, e.g., as a list of suitable services. This may be particularly well suited to contexts in which the list of services does not change frequently, or contexts in which the client-side components of the embedded secure function include a cache or data store that can be readily updated as the list changes.

In one aspect, transmitting the identified secure services (or more generally, establishing communications between the user device and an authentication aggregator) may include creating a secure connection between the user device and the authentication aggregator. This may, for example, include establishing a cryptographically secure connection between the user device and the authentication aggregator using any suitable protocols or non-standardized techniques suitable for securing an exchange of secret information over a public internetwork. For example, the user device and the authentication aggregator may use Transport Layer Security, Secure Socket Layer, or any other suitable protocol(s). In one aspect, a secure token may be communicated from the authentication aggregator to the user device once the identity of the user device has been established, thus permitting the identity of the user and/or user device to persist throughout the duration of a transaction. Where necessary or useful, this type of secure token may be configured for use in subsequent services. For example, the secure token may be stored in a secure cache on the user device and given an expiration time or duration suitable for subsequent transactions. In general, the secure token must also have suitable authorization from the issuer, e.g., the token would have an authorized scope of use, in time or in nature, beyond the current service request. The list of the secure services may then be securely transmitted to the device using secure connection and displayed, e.g., as a menu of selections in the user interface of the device.

As shown in step 410, the method 400 may include receiving a selection of one of the secure services from the user device, e.g., by interacting with a control displayed on the client device such as a drop-down list, radio button list, or the like. In this manner, the user may select a secure service suitable for processing the embedded secure function from among a number of available services. This may include a secure service, e.g., where a user has one or more pre-existing accounts.

As shown in step 412, the method 400 may include identifying an authentication protocol for authenticating to the selected secure service. Because the services managed through the authentication aggregator are independently operated by third parties, they can choose different authentication schemes, including any standardized or proprietary authorization schemes that each such entity believes suitably secure for the underlying services. This may, for example, include the use of different authentication protocols, the use of different identity management infrastructure, the use of different authentication factors, and so forth. In order to facilitate authentication by a single authentication aggregator in this environment, an authentication protocol may be stored for each secure service managed by the aggregator. This may include storing any related information, such as the name of an authentication protocol, a resource for trust (such as a certificate authority) or identity (such as an identity management platform), a website or URL for initiating authentication, one or more rules or steps to be taken during authentication, and so forth. This information may be stored at the authentication aggregator and used to orchestrate authentication in a manner suitable for each service that is accessible using the aggregator. Some or all of this information may also or instead be stored on a user device, for example where the embedded secure function includes a cache, data store, or the like suitable for storing corresponding information.

As noted above, any of a variety of authentication protocols, factors, and the like may be used. In one aspect, the user-selected authentication protocol may include one or more of a biometric authentication protocol using one or more biometric factors such as a fingerprint, facial recognition, voice recognition, and so forth. The user-selected authentication protocol may also or instead include a token-based authentication protocol using a hardware or software token such as a password generator (which may be a browser extension, separate hardware, etc.), a hardware security processor such as a Trusted Platform Module processor, a mobile device, or the like, a certificate-based authentication protocol using key material stored on the user device or a remote key management resource, a password-based authentication protocol, and so forth. Other information functionally associated with a user may also or instead be used as an authentication factor, such as an electronic mail address, phone number, or instant messaging user name, any of which can be used to send a verification communication to the user. In one aspect, the authentication protocol may be a multi-factor authentication protocol that uses two or more separate factors to verify the identity of a user. The authentication protocol may also use a variety of authentication standards or techniques including, without limitation, a Security Assertion Markup Language (SAML) protocol, an Open Authorization (OAuth) protocol, an Open Authorization 2.0 (OAuth2) protocol, a Lightweight Directory Access Protocol (LDAP), and a Kerberos protocol. More generally, any technique or combination of techniques consistent with the service provider, user policy requirements, and/or applicable industry standards, may be used as authentication protocols to support a transaction as described herein, and the particular combination of authentication techniques for each service provider may be stored by the authentication aggregator for selection and use based on the selection of a particular secure service from the user.

As shown in step 414, the method 400 may include identifying an application programming interface for programmatic interaction with the selected secure service. Each third party service may configure its own application programming interface independently from a selected authentication protocol/technique. Because the functional requirements for the programming interface are generally independent from the security requirements for choice and implementation of authentication techniques, these aspects of the service aggregation may advantageously be managed independently from one another, thus permitting modular use, and where appropriate for authentication protocols, re-use, of authentication components independently from each service's programming interface. This separation of security and interface functions also usefully maps to a corresponding separation in many authentication schemes such as OAuth 2.0 between an authorization server that supports identity management and a resource server that provides programmatic resources of the requested service (conditioned on the grant of access associated with an access token received from the authorization server for the user). Thus, authentication functions may advantageously be designed, tested, and deployed independently from programming interfaces.

As shown in step 416, the method 400 may include authenticating the user to the selected secure service with the selected authentication protocol. In general, the authentication may be supported by an authentication server or the like independent from the resource server that hosts functions of the secure service. Thus, the authentication may include a number of sub-steps depending on the selected authentication protocol for the selected secure service.

For example, in a first step of an authentication based on the OAuth 2.0 protocol, the user device may be redirected to a separate secure session between the user device and the selected secure service, or more specifically, to an authorization server associated with the secure service. This may include an authorization server hosted and operated by the secure service, or an authorization server hosted by another third party and controlled by the secure service. This may also or instead include any identity management platform suitable for verifying an identity of a user of the device and providing a cryptographically verifiable token of that identity to the authentication aggregator for use in subsequent communications with the secure service. The user may then authenticate to the selected secure service (or the authorization server associated with the secure service) using the selected protocol. This may include collecting user credentials or authentication factors, securing user consent to any applicable terms of use, and so forth. In general, these interactions are preferably conducted through a popup window, modal window, or other interface component on the end user device that is independent from the hosted content containing the embedded secure service, e.g., so that that user's secret information is not directly exposed to the host.

In a second step of this authentication, the user device may receive (through the secure session) a token from the authentication server, such as a secure token identifying the user. The token may include, or may be associated with, any suitable restrictions on the user's access to and use of the secure service. For example, the token may specify limits on data access, transaction types, and so forth. The scope of authorization granted by the token may be generally managed by an authorization server or the like associated with the secure service, in order to ensure that the access granted by the token is consistent with the identity of the user and the manner in which the user identity was asserted and verified (e.g., single factor, multi-factor, hardware-token based, etc.).

In a third step of this authentication, the user device may transmit the token to the authentication aggregator, e.g., through a secure communications link.

In a fourth step of this authentication, the authentication aggregator may sign the token with a private key stored by the authentication aggregator, and associated with a public key that can be used by the secure service to verify the identity of the source of the signed token. The private key may, for example, be provided by the selected secure service, or provided by a trusted third party, certificate authority, or the like that is trusted by the secure service to provide a private-public key pair to the authentication aggregator. A variety of techniques may be used to support a verifiable assertion of identity in this context, and any such technique may be used, provided it satisfies the security requirements of the underlying secure services being accessed.

In a fifth step, the authentication aggregator may create a second secure session with the secure service through which the secure service can verify the identity of the user and the authentication aggregator.

In a sixth step, the secure service, or an authorization server for the secure service, may issue an access token to the authentication aggregator, which may, for example, include the signed token from the authentication aggregator, and which may also be signed or otherwise cryptographically encoded to facilitate verification of the secure service. This access token may then be stored by the authentication aggregator and used by the authentication aggregator to support secure communications with the secure service on behalf of the user (and within the scope of services authorized by the user device and the authentication server when the original user token was created).

In one aspect, an access token as contemplated herein may grant authorization for bi-directional communications between the authentication aggregator and the secure service. As a significant advantage, this may permit the authentication aggregator to transmit instructions to the secure service and request information from the secure service, e.g., so that the authentication aggregator can request information to assist a user in disambiguation as described herein, or request additional information in association with error handling and so forth.

It will be understood that, in one aspect, the embedded secure function, whether presented as a hyperlink, icon, image or other interactive control, may be associated with a single, predetermined secure service. In this manner, a service provider may insert a link, icon, or other control for direct access to the service provider in web content, electronic communications, and the like. In such embodiments, the steps above for resolving the secure service may be omitted, and the user may be directed immediately to an authorization server for the predetermined secure service associated with the embedded secure function. Upon a successful conclusion of an authentication using a predetermined authentication protocol of the secure service, the authentication aggregator may communicate with the secure service using a predetermined programming interface associated with the secure service, and the method 400 may proceed directly to disambiguation of parameters and any subsequent steps as described below. Thus, the techniques described herein may continue to provide advantages, such as disambiguation of processing parameters or context-specific adaptations of the user experience, even when a single secure service is available.

As shown in step 418, the method 400 may include disambiguating one or more processing parameters for the request. For example, this may include disambiguating one or more purchase parameters for a purchase or other transaction. In general, an embedded secure function as described herein may contain an under-constrained request, leaving any of a number of processing parameters that need disambiguation before the request that can be programmatically processed by the secure service. In one aspect, one or more parameters may be automatically disambiguated, e.g., where the context of the request permits meaningful inferences to be drawn about user intent. For example, where browser history indicates a user already has secure credentials for a particular service, this secure service may be preselected for executing the embedded secure function. As another example, the web site hosting the embedded secure function, a user search history, a history of usage stored at the authentication aggregator, or current keywords or the like may provide information useful for automated disambiguation, or at least for generating disambiguation suggestions. At the same time, disambiguation may require data from the user, from the secure service, from third party data sources, or some combination of these. The authentication aggregator may usefully orchestrate the acquisition, processing, and presentation of data if/as necessary to create a complete request suitable for submission to the secure service.

In one aspect, this includes identifying a suitable service as described above. However, other data such as price, quantity, timing, content, purchase restrictions, biographical information, account identification, and other mandatory and/or optional processing parameters may be provided prior to initiating a request to a secure service.

In another aspect, disambiguating one or more processing parameters includes selecting an account for the user at the selected secure service. For example, a user may have a number of different accounts associated with a single user identity or login credentials. In order to ensure that a request is executed using the correct account, the authentication aggregator may initially evaluate whether there is more than one account associated with the identity of the user at the secure service. If so, then the authentication aggregator may retrieve and present a list of the accounts to the user device along with a request for an explicit selection of one of the accounts. If not, then the authentication aggregator may continue to gather other information if/as needed to disambiguate any remaining processing parameters.

In another aspect, disambiguating one or more processing parameters includes verifying funds in an account for the user sufficient for the requested service. This may also or instead be performed as an error handling step as described below. The disambiguation may include a change (or request for a user change) in a requested transaction such as a purchase quantity or a service level, based on the funds or payment sources associated with a user account.

As shown in step 420, the method 400 may include error handling. For a variety of reasons, a request submitted to a secure service may fail, and may produce an error message. One significant source of such errors may be a request outside the scope of a current account or user for which the request was authenticated. For example, a request to add a node to a server cluster in a cloud computing platform may exceed a user quota for computing resources. Or a request to purchase an item may exceed a credit limit on a credit card, or a balance in a brokerage or bank account. Where quantitative data concerning the insufficiency is available, this information may be communicated to the user by the authentication aggregator to facilitate order refinement by the user.

As shown in step 422, the method 400 may include previewing a service request. For example, this may include presenting a preview of a transaction, an item of digital content, or the like to the user in the user interface of the device based on the processing parameters, as disambiguated in step 418.

As shown in step 424, the method 400 may include receiving a confirmation from the device based on the preview. In general, a request for the confirmation may be presented to the user along with the preview, thus providing the user with an opportunity to verify the request before it is irrevocably presented to the secure service for execution. In another aspect, the preview may be omitted, and the request may be automatically initiated in response to full disambiguation of processing parameters by the user.

As shown in step 426, the method 400 may include processing the request with the secure service based on the processing parameters and the preview using the selected application programming interface. In one aspect, the user device is not interacting directly with the secure service at this time, although it is possible to directly couple a user device to the secure service for any one or more of the steps described herein. Thus, when the user presents a confirmation of the previewed transaction to the authentication aggregator, the authentication aggregator may, in turn, present the fully disambiguated request to the secure service for execution.

Any number of additional steps may be performed. For example, while the secure service can communicate a confirmation to a user after successful execution of a request, the authentication aggregator may also or instead present a confirmation in the user interface upon notification from the secure service that the order has been completed.

In another aspect, the access token used by the authentication aggregator to communicate with the secure service may optionally be explicitly deactivated (e.g., as distinguished from expiring) at any time in order to prevent subsequent transactions based on the original grant of authorization from the authorization server. In another aspect, the access token may be persisted and stored in a cache on a user device to permit subsequent activity by the user through the authentication aggregator without requiring re-authentication to the secure service's authorization server.

More generally, the methods and systems described herein may advantageously support the flexible and seamless placement of a secure function in any media, content, or network location using secure services supported by one or more different third-party platforms. In one aspect, the host or content owner may also control which third-party platform(s) are made available to site visitors. For example, the host may select a single third party platform as a preferred provider of secure services, and that third party platform may be the only option presented to the user for performing a transaction with the purchase widget or other tool. In another aspect, the host may include two or more preferred service providers for display in a selection list, requiring the user to select from among the host's pre-chosen provider for processing requests using the widget/tool.

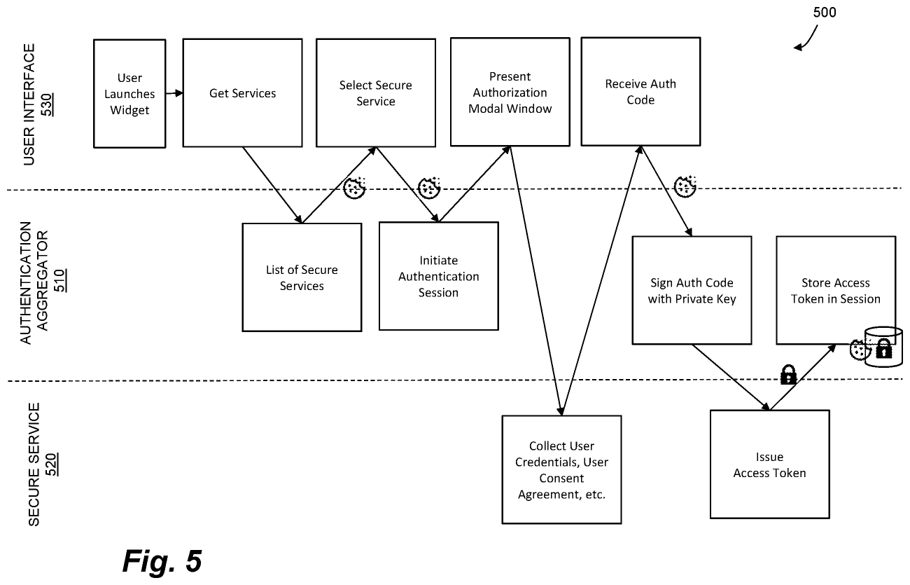

FIG. 5 illustrates a process for an authentication aggregator to obtain an access token for a user. More specifically, FIG. 5 illustrates a process 500 by which the authentication aggregator 510 (such as any of the authentication aggregators described herein) obtains an access token that permits the authentication aggregator 510 to access a secure service 520 (such as any of the secure services described herein) on behalf of a user who is interacting with a user interface 530 containing a widget, embeddable secure function, or the like as described herein.

In general, the example process begins when a user launches a widget or other interface element or control containing an embeddable secure function such as any of those described herein. In one aspect, this may be a dynamic control that selects a type or scope of service based on context such as the web page in which the control is deployed, a user's browser history or cache, keywords or user profile data, or any other context available to the control (or the authentication aggregator 510) when the control is presented in a user interface 530. Where the host of the embeddable secure transaction (or the local user interface) does not include a list of available services, the user device may responsively navigate to the authentication aggregator 510 with a request for a current list of secure services 520, along with any other information necessary or helpful for resolving a user request for a specific service. This data may be transmitted to the user device as a code segment for presentation in the user interface 530, more specifically in a user interface element that permits user selection from among the listed services. The data from the authentication aggregator 510 may also include a secure session token for maintaining secure communications between the user device and the authentication aggregator 510.

The user device may then present a request for one of the listed secure services to the authentication aggregator 510, which may responsively select a suitable authentication location and/or protocol, and direct the user device (or the user interface 530 of the user device) to a modal window, pop-up, or other isolated user interface element hosted by the secure service 520 for authentication. In this process, the secure service (or an authorization server or the like for the secure service 520) may authenticate a user of the user device using any of the techniques described herein. The secure service 520 may also gather explicit user consent, e.g., to place requests to the secure service 520 via the authentication aggregator 510. Upon completion of this authentication process, the secure service 520 may transmit an authorization code to the user device. The user device (or user interface 530 of the user device) may then transmit this authorization code to the authentication aggregator 510 along with the session cookie, and the authentication aggregator 510 can sign the authorization code with a private key. This data may then be transmitted to the secure service 520, permitting the secure service 520 to cryptographically verify the user and the authentication aggregator 510.

In response, the secure service 520 may cryptographically verify the user and the authentication aggregator 510, and issue an access token to the authentication aggregator 510 for use of the secure service 520 on behalf of the user. The access token may be constrained in any manner desired by the secure service 520, and may limit access to a period of time, a scope of service access (e.g., number of transactions, type of transactions, etc.), and so forth. Thus, in general, the access token may be a temporary access token or request-specific access token that is expressly limited in time or scope to a particular use of the secure service 520. The access token may, for example, be a one-time-use token for a single, real time use of the secure service 520 that has been specifically requested by the user. The access token may also or instead be made into an effective one-time-use token by explicitly deleting the access token at the authentication aggregator 510, or revoking the token at the secure service 520, which advantageously permits either entity to expire the token upon confirmation of the initiation or completion of a request action by the secure service 520 (while also generally preventing use of the access token directly from the user device). This scope of use, when consistent with the consent agreement provided by the user, may also permit the secure service 520 to ensure that the scope of services requested by the authentication aggregator 510 does not exceed the scope of services authorized by the user, or the scope of services provided by terms of service between the user and the secure service 520. Expiring the token after completion of the requested services can also help to prevent malicious access to the secure service 520 using replay-type attacks that re-use a token maliciously acquired from another source.

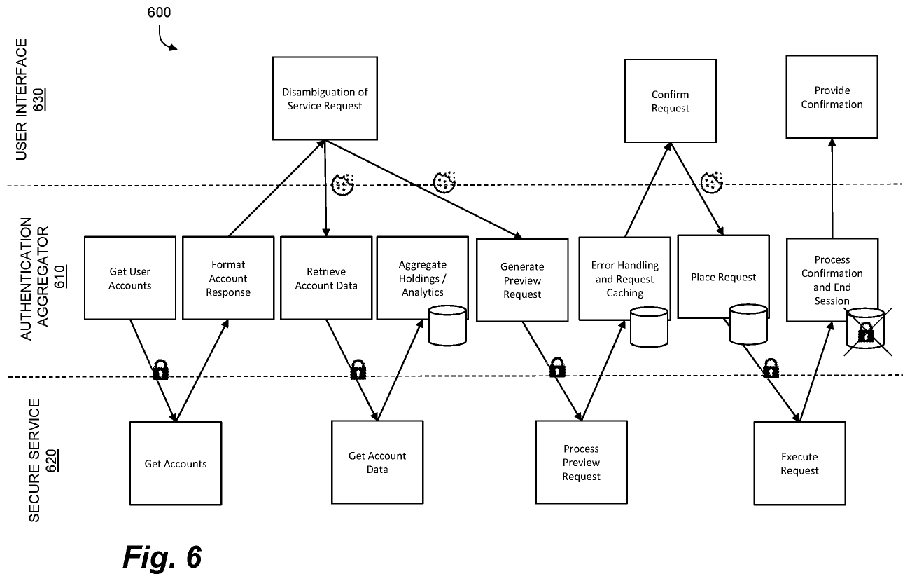

FIG. 6 illustrates a process for using an access token. More specifically, FIG. 6 illustrates a process 600 by which the authentication aggregator 610 (such as any of the authentication aggregators described herein) uses an access token from a secure service 620 (such as any of the secure services described herein) to access the secure service 620 on behalf of a user who is interacting with a user interface 530 containing a widget, embeddable secure function, or the like as described herein.

In order to assist in disambiguation of a request from the user, the authentication aggregator 610 may retrieve user accounts from the secure service 620. The authentication aggregator 610 may format the response from the secure service 620 and present a list of accounts to the user device for presentation in the user interface 630. Where the secure service 620 only permits one account per user, this step may be omitted. In either case, the authentication aggregator 610 may usefully retrieve account data for the user, such as any account information necessary or helpful for processing the user request, or otherwise supporting the user or the authentication aggregator 610. For example, where the account is a brokerage account, this may include retrieving account holdings, buying power and the like, e.g., to assist in automated disambiguation of user requests, pre-process customer orders for validity, or, where privacy rules and user consents permit, to generate user level or (anonymized and) aggregated analytics. Disambiguation may also or instead include resolving parameters for incomplete service requests related to time and scope of services, details of the service request, and so forth.

Upon automated and/or manual disambiguation of a service request, the authentication aggregator 610 may request a preview. This may help to prevent erroneous or inadvertent requests from being transmitted to the secure service 620 for processing, and can also help each party to ensure that a request by the user is being properly and accurately conveyed to a corresponding secure service for processing. As a significant advantage, this approach may expand upon the usual safeguards for a user and a secure service 620 by providing complimentary assurances to an intermediate authentication aggregator that is facilitating the requested interaction. The preview request may be transmitted to the secure service 620 where it can be inspected so that the complete, disambiguated request can be processed by the secure service 620. The authentication aggregator 610 may receive a response from the secure service 620, analyze the response for possible errors, e.g., based on an error code or request denial from the secure service 620. The authentication aggregator 610 may also cache the request as necessary and helpful for finalizing the request with the service provider.

Upon receiving an error free response to the preview request including, e.g., a description of the requested service(s) from the secure service 620, the authentication aggregator 610 may communicate the preview and any associated data to the user interface 630 for review and confirmation by the user. The user may then submit a confirmation to the authentication aggregator 610, which may retrieve the cached request and transmit the cached request to the secure service 620 for execution.

Upon receipt from the secure service 620 of a confirmation that the requested service has been initiated or completed, the authentication aggregator 610 may transmit the confirmation to the end user device for display in the user interface 630. The authentication aggregator 610 may also or instead delete the access token in order to prevent accidental or malicious access to the secure service 620 based on a request-specific token granted to the user and authentication aggregator 610.

The above systems, devices, methods, processes, and the like may be realized in hardware, software, or any combination of these suitable for a particular application. The hardware may include a general-purpose computer and/or dedicated computing device. This includes realization in one or more microprocessors, microcontrollers, embedded microcontrollers, programmable digital signal processors or other programmable devices or processing circuitry, along with internal and/or external memory. This may also, or instead, include one or more application specific integrated circuits, programmable gate arrays, programmable array logic components, or any other device or devices that may be configured to process electronic signals. It will further be appreciated that a realization of the processes or devices described above may include computer-executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software. In another aspect, the methods may be embodied in systems that perform the steps thereof, and may be distributed across devices in a number of ways. At the same time, processing may be distributed across devices such as the various systems described above, or all of the functionality may be integrated into a dedicated, standalone device or other hardware. In another aspect, means for performing the steps associated with the processes described above may include any of the hardware and/or software described above. All such permutations and combinations are intended to fall within the scope of the present disclosure.

Embodiments disclosed herein may include computer program products comprising computer-executable code or computer-usable code that, when executing on one or more computing devices, performs any and/or all of the steps thereof. The code may be stored in a non-transitory fashion in a computer memory, which may be a memory from which the program executes (such as random-access memory associated with a processor), or a storage device such as a disk drive, flash memory or any other optical, electromagnetic, magnetic, infrared, or other device or combination of devices. In another aspect, any of the systems and methods described above may be embodied in any suitable transmission or propagation medium carrying computer-executable code and/or any inputs or outputs from same.

The method steps of the implementations described herein are intended to include any suitable method of causing such method steps to be performed, consistent with the patentability of the following claims, unless a different meaning is expressly provided or otherwise clear from the context. So, for example, performing the step of X includes any suitable method for causing another party such as a remote user, a remote processing resource (e.g., a server or cloud computer) or a machine to perform the step of X. Similarly, performing steps X, Y, and Z may include any method of directing or controlling any combination of such other individuals or resources to perform steps X, Y, and Z to obtain the benefit of such steps. Thus, method steps of the implementations described herein are intended to include any suitable method of causing one or more other parties or entities to perform the steps, consistent with the patentability of the following claims, unless a different meaning is expressly provided or otherwise clear from the context. Such parties or entities need not be under the direction or control of any other party or entity, and need not be located within a particular jurisdiction.

It will be appreciated that the devices, systems, and methods described above are set forth by way of example and not of limitation. Absent an explicit indication to the contrary, the disclosed steps may be modified, supplemented, omitted, and/or re-ordered without departing from the scope of this disclosure. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the spirit and scope of this disclosure and are intended to form a part of the invention as described herein.

What is claimed is:

1. A computer program product comprising computer executable code embodied in a non-transitory medium that, when executing on one or more computing devices, performs the steps of:
receiving a request for processing from a user within a user interface of a device;
in response to receiving the request, identifying a number of secure services suitable for processing the request;
creating a first secure connection with the device;
transmitting a list of the number of secure services to the device, using the first secure connection, for display as a menu of selections in the user interface;
receiving, from the device and using the first secure connection, a selection of a selected secure service from the number of secure services;
in response to receiving the selection, identifying an authentication protocol for authenticating to the selected secure service and an application programming interface for programmatic communications with the selected secure service;
redirecting the device to a secure session between the device and the selected secure service for the user to authenticate to the selected secure service using the authentication protocol;
receiving a first token from the device asserting a successful authentication of the user to the selected secure service;
signing the first token with a key received from the selected secure service to provide a second token;
creating a second secure connection with the selected secure service using the second token;
disambiguating one or more processing parameters for the request;
presenting a preview of a processed request by the selected secure service based on the one or more processing parameters to the user interface of the device;
receiving a confirmation to process the request from the device based on the preview; and
initiating processing of the request with the selected secure service based on the one or more processing parameters using the second secure connection and the application programming interface.

2. A method for supporting a secure request processing, the method comprising:
receiving a response to a request for processing from a user of a device;
receiving, in a user interface of the device, a selection from the user of a secure service suitable for processing the request;
identifying an authentication protocol for authenticating to the secure service and an application programming interface for programmatic communications with the secure service;
authenticating the user to the secure service with the authentication protocol;
disambiguating one or more processing parameters for the request;
presenting a preview of a processed request to the user on the device based on the one or more processing parameters;
receiving a confirmation from the device based on the preview; and
initiating processing of the request with the secure service based on the one or more processing parameters using the application programming interface.

3. The method of claim 2, wherein the request includes a hyperlink to an authentication aggregator.

4. The method of claim 2, wherein the request includes an embed code.

5. The method of claim 2, wherein the request includes a software development kit installed on a website hosting the request.

6. The method of claim 2, wherein the request includes a quick response code display to the user on the device.

7. The method of claim 2, wherein the authentication protocol includes one or more of a biometric authentication protocol, a token-based authentication protocol, a certificate based authentication protocol, a password-based authentication protocol, and a multi-factor authentication protocol.

8. The method of claim 2, wherein the authentication protocol includes one or more of a Security Assertion Markup Language (SAML) protocol, an Open Authorization (OAuth) protocol, an Open Authorization 2.0 (OAuth2) protocol, a Lightweight Directory Access Protocol (LDAP), and a Kerberos protocol.

9. The method of claim 2, wherein the authentication protocol uses a trusted third party.

10. The method of claim 2, wherein the authentication protocol uses a third party identity management service.

11. The method of claim 2, wherein the user interface displays a web page containing the request.

12. The method of claim 2, wherein the user interface displays an electronic mail containing the request.

13. The method of claim 2, wherein the user interface displays a text message containing the request.

14. The method of claim 2, wherein the user interface includes at least one of a virtual reality environment containing the request and an augmented reality environment containing the request.

15. The method of claim 2, wherein disambiguating one or more processing parameters includes selecting an account for the user at the secure service.

16. The method of claim 2, further comprising storing a database of a plurality of authentication protocols, each one of the plurality of authentication protocols associated with one of a plurality secure services.

17. The method of claim 2, further comprising storing a database of a plurality of application programming interfaces, each one of the plurality of application programming interfaces associated with one of a plurality of secure services.

18. The method of claim 2, further comprising storing a database of private keys, each one of the private keys used for securing communications with one of a plurality of secure services.

19. A middleware system for aggregating authentication to secure services, the middleware system comprising:
a database storing information for a plurality of external secure services, the information including a private key, an application programming interface, and an authentication protocol for each of the plurality of external secure services;
a user interface module configured to receive a response to request for processing from a user device through a data network;
a services interface module configured to communicate with the plurality of external secure services; and
a processing engine configured to:
process the request by redirecting the user device to an authenticator for authenticating a user of the device using a corresponding one of the authentication protocols,
disambiguate a processing parameter for the request,
establish a secure connection with a user-selected secure service of the plurality of external secure services using a corresponding one of the private keys, and
initiate processing of the request through the secure connection with the user-selected secure service using a corresponding one of the application programming interfaces for programmatic access to the user-selected secure service.

20. The middleware system of claim 19, wherein the processing engine is further configured to receive a selection of the user-selected secure service from the user device, and to select the corresponding one of the authentication protocols, private keys, and application programming interfaces for initiating processing of the request with the user-selected secure service.
